(19) United States
(12) Patent Application Publication
(10) Pub. No.: US 2005/0287056 A1
(43) Pub. Date: Dec. 29, 2005

(54) Removal of methyl mercaptan from gas streams

(75) Inventors: Gene Baker, Hazen, ND (US); Myria Perry, Beulah, ND (US); Daren Eliason, Beulah, ND (US)

Correspondence Address: ALIX YALE & RISTAS LLP, 750 MAIN STREET, SUITE 1400, HARTFORD, CT, 06103, US

(73) Assignee: Dakota Gasification Company

(21) Appl. No.: 10/879,281

(22) Filed: Jun. 29, 2004

(51) Int. Cl. B01D 53/50

(52) U.S. Cl. 423/242.1

(57) ABSTRACT

The invention described herein is a method for selectively removing mercaptans such as methyl mercaptan from dry gas mixtures containing high concentrations of carbon dioxide. In the method, the carbon dioxide-rich gas (sour gas) is passed through an absorption vessel or distillation column in which it is contacted with an absorbent such as liquid carbon dioxide in order to selectively absorb the mercaptans. The treated gas, which is now free of mercaptans, leaves the top of the vessel as a sales gas suitable for use in enhanced oil recovery applications. Preferably, a portion of the carbon dioxide in the sales gas is condensed and the liquid is returned to the absorber or distillation column as the scrubbing agent. At least part of this scrubbing agent leaves the bottom of the absorber or distillation column enriched in methyl mercaptan and other sulfur compounds. The stream from the absorption vessel containing the mercaptans can be incinerated or otherwise processed to utilize or dispose of the methyl mercaptan.

### BACKGROUND OF THE INVENTION

The invention generally relates to methods for purifying carbon dioxide gas streams, and more particularly to methods for reducing the concentration of mercaptans in gas mixtures containing high concentrations of carbon dioxide.

Oil-field-grade carbon dioxide (CO₂), such as is produced from lignite coal gasification, is generally contaminated with a variety of fuel gas and sulfur compounds. The contaminants include hydrogen sulfide (H₂S), carbonyl sulfide (COS), methyl mercaptan (CH₃SH), and C₂- and C₃-hydrocarbons, along with numerous other minor constituents. When oil-field-grade carbon dioxide is used for enhanced oil recovery projects, the methyl mercaptan, along with some of the other sulfur compounds, is of concern because it leaves the gas handling equipment and piping with an unpleasant and lingering odor. Furthermore, it is believed that the methyl mercaptan and other sulfur compounds might react with the crude oil to effectively increase its sulfur content and thus reduce its quality and sales value. It would be useful to develop a process for selectively removing mercaptans, such as methyl mercaptan, and certain other organic sulfur compounds from dry gas mixtures rich in CO₂ and concentrating them into a smaller stream for efficient processing or disposal.

### SUMMARY OF THE INVENTION

It is an object of the invention to provide a method of purifying a carbon dioxide gas stream to render it useful in a variety of ways, including in enhanced oil recovery projects.

Another object of the invention is to provide a dry gas stream that can be used to recover oil and that does not leave the gas handling equipment and piping with lingering and unpleasant odors.

A further object of the invention is to provide a continuous flow process for purifying a carbon dioxide gas stream which has varying mercaptan impurity levels.

Yet another object of the invention is to provide an efficient method of producing a mercaptan-free carbon dioxide gas stream as a by-product of lignite coal gasification.

The invention in a preferred form is a method of removing methyl mercaptan from a carbon dioxide gas stream, comprising the steps of: (a) obtaining a first gas stream comprising at least 80 volume percent carbon dioxide and up to 500 parts per million based on volume of methyl mercaptan, and (b) contacting the first gas stream with a liquid carbon dioxide stream under conditions sufficient to produce a first liquid stream containing at least 85 weight percent of the methyl mercaptan from the first gas stream and a second gas stream containing at least 90 weight percent of the carbon dioxide from the first gas stream.

Preferably, the contacting step takes place in an absorber or a distillation column. The column generally has a reflux ratio of at least eight pounds of liquid carbon dioxide per 100 pounds of the first gas stream. The first gas stream is usually compressed and cooled prior to being contacted with the liquid carbon dioxide stream. Optionally, the first gas stream is dehydrated prior to being contacted with the liquid carbon dioxide stream.

In one preferred form of the invention, at least a portion of the second gas stream is condensed to form the liquid carbon dioxide stream. Preferably, at least a portion of the second gas stream is condensed and used to cool the first gas stream. Furthermore, at least a portion of the first liquid stream can be used to cool the first gas stream. The contacting step preferably takes place in a column having an operating pressure in the range of 280 to 360 psig and a temperature in the range of −5 to 15° F. at the top of the column. The column preferably has a reflux ratio in the range of 8-16 and more preferably 10-14 pounds of liquid carbon dioxide per 100 pounds of the first gas stream. At least a portion of the second gas stream can be cooled by conventional refrigeration or autorefrigeration. Autorefrigeration preferably takes place in an absorption column or a heat exchanger.

In one form of the invention, the methyl mercaptan content of the second gas stream is no more than 20 parts per million based on volume (ppmv), and more preferably is no more than 10 ppmv. The second gas stream preferably contains at least 90 weight percent, and even more preferably at least 95 weight percent of the total gas components from the first gas stream. The second gas stream desirably contains at least 99 weight percent of the total gas components from the first gas stream.

In one embodiment, the method further comprises the step of (f) concentrating the methyl mercaptan in the first liquid stream by reboiling the first liquid stream to evaporate a portion of the carbon dioxide therein and recycling the evaporated carbon dioxide to step (b).

Another preferred form of the invention is a method of removing methyl mercaptan from a carbon dioxide gas stream, comprising the steps of: (a) obtaining a first gas stream comprising at least 80 volume percent carbon dioxide and up to 500 parts per million based on volume of methyl mercaptan, (b) compressing the first gas stream to a pressure of 70 psig to 1100 psig, (c) cooling the first gas stream to a temperature of −60° F. to 90° F., and (d) contacting the first gas stream with an absorbent to produce a first liquid stream containing at least 85 weight percent of the methyl mercaptan from the first gas stream and a second gas stream containing at least 90 weight percent of the carbon dioxide from the first gas stream. Usually, at least a portion of the first liquid stream cools the first gas stream. The contacting step preferably takes place in a column having a reflux ratio of at least eight pounds of liquid carbon dioxide per 100 pounds of the first gas stream and preferably about twelve pounds of liquid carbon dioxide per 100 pounds of the first gas stream.

### BRIEF DESCRIPTION OF THE DRAWINGS

Other features and advantages of the invention are further described in the following detailed description of preferred embodiments of the invention, considered in conjunction with the drawings, in which:

FIG. 1 is a general schematic flow diagram for using a reboiled absorber according to the invention to remove methyl mercaptan from a sour CO₂-rich feed gas, with conventional refrigeration being used for cooling and condensing the carbon dioxide;

FIG. 2 is a general schematic flow diagram for using a simple absorber according to the invention to remove methyl mercaptan from a sour CO₂-rich feed gas, with conventional refrigeration being used for cooling and condensing the carbon dioxide;

FIG. 3 is a general schematic flow diagram for using a reboiled absorber according to the invention to remove methyl mercaptan from a sour CO₂-rich feed gas with autorefrigeration being used for cooling and condensing a portion of the purified CO₂ gas stream; and

FIG. 4 is a general schematic flow diagram for using a simple absorber according to the invention to remove methyl mercaptan from a sour CO₂-rich feed gas with autorefrigeration being used for cooling and condensing a portion of the purified CO₂ gas stream.

### DETAILED DESCRIPTION OF THE INVENTION

The present invention provides a highly effective and efficient method of removing mercaptans and similar odorous substances from a sour CO₂-rich gas stream. The sweetened or treated CO₂-rich gas can be used for enhanced oil recovery operations such as tertiary oil recovery, thereby increasing the overall percentage of oil that can be recovered from a particular well in an economical manner. The process of the invention preferably involves scrubbing a sour CO₂-rich gas stream such as oil-field-grade gas with liquid carbon dioxide (CO₂), however, the same effect can be achieved by configuring the process for distillation. The process is continuous and preferably starts by first compressing the dry, sour, CO₂-rich gas stream to a pressure in the range of 70 psig to 1100 psig, more preferably between 280 psig and 360 psig, with the range of 280 psig to 300 psig being most preferred. Some cooling can take place before compression if the gas stream is hot. After compression, the sour CO₂-rich gas stream is cooled first to remove the heat of compression and then to lower its temperature to the condensation point of carbon dioxide at the operating pressure employed. The sour CO₂-rich feed preferably is cooled in one or more cooling stages to a temperature in the range of −60° F. to 90° F., more preferably −5° F. to 15° F., and most preferably −5° F. to 5° F. Next, the cooled gas is passed upwardly through a tray or packed column, where it is brought into contact with a counter flowing stream of liquid carbon dioxide. The methyl mercaptan in the sour carbon dioxide-rich gas stream is physically absorbed by the liquid CO₂, and is removed from the upwardly flowing gas. Of the treated gas that leaves the top of the column, a portion is further refrigerated and condensed to produce liquid CO₂ for scrubbing and cooling the fresh sour gas that enters the system. The remainder of the treated gas is further compressed and transported or piped to the oil fields for underground injection, or to another site where it is to be further processed and/or used.

The liquid CO₂ containing the methyl mercaptan is collected in the bottom of the column and preferably is further concentrated by evaporation of the excess CO₂. The evaporated excess CO₂ passes upwardly through the column, where it mixes with fresh sour feed. This concentration step is done using either a conventional reboiler (distillation or reboiled absorption) or through direct heat exchange by commingling with the warm sour feed gas (simple absorption). The concentrated methyl mercaptan stream is then removed from the bottom of the column and incinerated or processed further for recovery of the CO₂ and absorbed components. In the process of the invention, the loss of CO₂ with the methyl mercaptan and other sulfur compounds typically is no more than 5 weight percent of the CO₂ in the feed gas, and preferably is no more than 3 weight percent of the CO₂ in the feed gas.

Refrigeration for the process can be accomplished either by conventional refrigeration techniques using ammonia or another suitable refrigerant, or by autorefrigeration using some of the treated gas. Wet CO₂-rich feed streams may be capable of being processed through the methyl mercaptan removal system if the operating pressure and temperature are sufficiently high to prevent freezing of water, or if they are first processed through a dehydrator to remove the moisture.

Typical sources of CO₂-rich gas that may be contaminated with mercaptans include by-product CO₂ streams from lignite, subbituminous coal, and biomass gasification plants, fermentation plants, direct coal liquefaction plants and underground coal gasification facilities. In addition, some natural sources of CO₂ may also contain mercaptans, as may the CO₂ effluent from natural gas sweetening plants and other processes when Rectisol® or similar absorption steps are used to remove and concentrate acid gases. The sour feed stream typically has a CO₂ content of at least 80 volume %, more preferably at least 85 volume %, and most preferably at least 90 volume %. The methyl mercaptan content of the sour feed stream generally is no more than 500 ppmv, preferably is 50 to 400 ppmv, and usually is in the range of 100-350 ppmv.

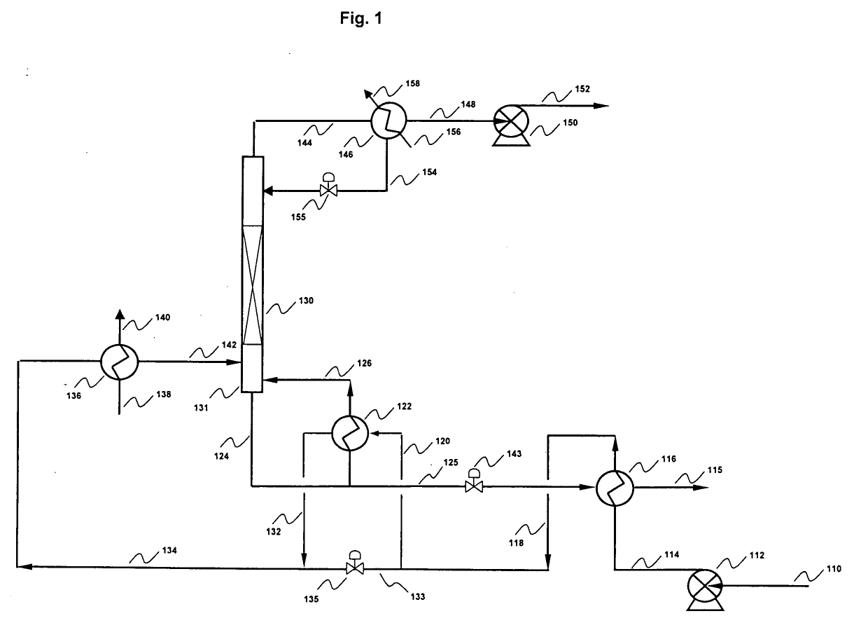

With reference to FIG. 1, a gas stream in conduit 110 from a coal gasification operation or from a gas purification process, such as Rectisol®, containing a high concentration of carbon dioxide along with sulfur compounds such as methyl mercaptan, hydrogen sulfide, dimethyl disulfide, ethyl mercaptan, propyl mercaptan, dimethyl sulfide and the like is conveyed to a compressor 112 for pressurization and further treatment according to the invention. The pressurized gas is conveyed through conduit 114 to a cooler/evaporator 116 which cools the compressed gas while also evaporating liquid waste-gas in conduit 125, which is under the control of level valve 143. The evaporated waste-gas leaves the unit through conduit 115 and is disposed of by incineration or is processed using other treatment methods. The cool compressed gas leaves the cooler/evaporator 116 through conduit 118. A portion of the gas in conduit 118 is routed through conduit 120 and into a reboiler 122 where it is used to concentrate the liquid waste-gas in conduit 124 by evaporating a portion of it. The evaporated waste-gas leaves the reboiler 122 in conduit 126 and returns to the absorber 130. The compressed gas used in the reboiler leaves in conduit 132 and blends back with the compressed gas from conduit 133 in conduit 134. The temperature valve 135 in conduit 133 controls the amount of heat applied to the reboiler 122 so that the correct bottoms flow is obtained from the column in conduit 124. Conduit 134 conveys the compressed gas to cooler/evaporator 136 where the compressed gas is cooled to near its condensation temperature by evaporating liquid ammonia or some other refrigerant.

The refrigerant enters the cooler/evaporator 136 as a liquid through conduit 138 and leaves the cooler/evaporator as a vapor in conduit 140. The cold compressed gas is conveyed in conduit 142 to the absorber 130. The cold compressed gas flows upwardly through the absorber 130 where it is contacted with a downwardly flowing stream of liquid carbon dioxide. The liquid carbon dioxide absorbs methyl mercaptan along with various amounts of other sulfur compounds and collects in a sump 131 at the bottom of the absorber 130 to form a liquid waste-gas. The liquid waste-gas leaves the sump 131 at the bottom of the absorber 130 through conduit 124 and is heated and evaporated as explained previously. Treated gas leaves the top of the absorber 130 through conduit 144 and is conveyed to condenser/evaporator 146, where a portion of the treated gas is condensed by evaporating a refrigerant. Liquid refrigerant in conduit 156 enters the bottom of the condenser/evaporator 146 and leaves as a vapor in conduit 158. The non-condensed treated gas leaves the condenser/evaporator 146 in conduit 148 and is conveyed to a compressor 150 where it is further pressurized for export in conduit 152 to the consumer. The portion of the treated gas which is condensed in the condenser/evaporator 146 returns to the top of the absorber 130 in conduit 154 under flow control through flow valve 155 and flows downwardly through the absorber 130 to scrub and cool the gas which enters the absorber 130 in conduit 142.

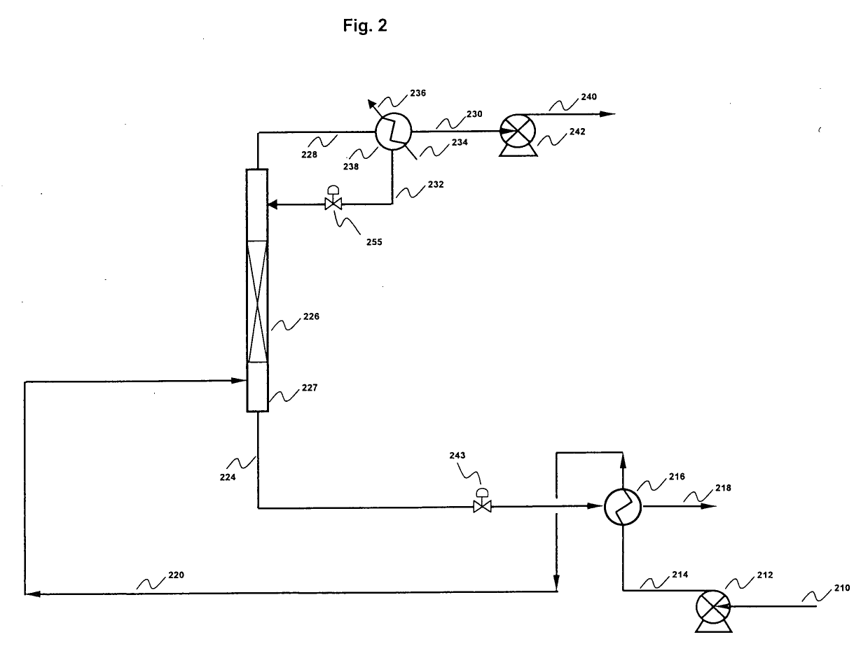

With reference to FIG. 2, a gas stream in conduit 210 from a coal gasification operation or from a gas purification process, such as Rectisol®, containing a high concentration of carbon dioxide along with sulfur compounds such as methyl mercaptan, hydrogen sulfide, dimethyl disulfide, ethyl mercaptan, propyl mercaptan, dimethyl sulfide and the like is conveyed to a compressor 212 for pressurization and further treatment according to the invention. The pressurized gas is conveyed through conduit 214 to a cooler/evaporator 216 which cools the compressed gas while also evaporating liquid waste-gas. The evaporated waste-gas leaves the unit through conduit 218 and is disposed of by incineration or is processed using other treatment methods. The cool compressed gas leaves the cooler/evaporator 216 through conduit 220. Conduit 220 conveys the compressed gas to the absorber 226 where the compressed gas is cooled to near its condensation temperature by evaporating some of the liquid carbon dioxide that is flowing inside the absorber. The cold compressed gas flows upwardly through the absorber 226 where it is contacted with a downwardly flowing stream of liquid carbon dioxide. The liquid carbon dioxide absorbs methyl mercaptan along with various amounts of other sulfur compounds and collects in a sump 227 at the bottom of the absorber 226 to form a liquid waste-gas. The liquid waste-gas leaves the bottom of the absorber 226 through conduit 224 under the control of level valve 243 and is heated and evaporated as explained previously. Treated compressed gas leaves the top of the absorber 226 through conduit 228 and is conveyed to condenser/evaporator 238, where a portion of the treated gas is condensed by evaporating a refrigerant. Liquid refrigerant in conduit 234 enters the bottom of the condenser/evaporator 238 and leaves as a vapor in conduit 236. The non-condensed treated gas leaves the condenser/evaporator 238 in conduit 230 and is conveyed to a compressor 242 where it is further pressurized for export in conduit 240 to the consumer. The portion of the treated gas which is condensed in the condenser/evaporator 238 returns to the top of the absorber 226 in conduit 232 under the control of flow valve 255 and flows downwardly through the absorber 226 to scrub and cool the gas which enters the absorber 226 in conduit 220.

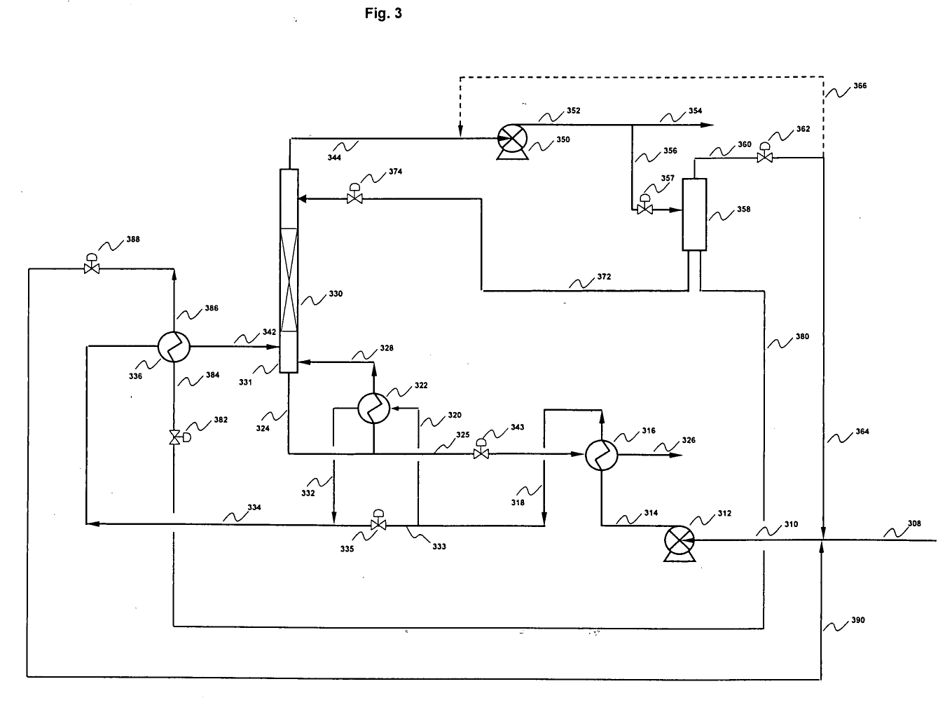

With reference to FIG. 3, a gas stream in conduit 308 from a coal gasification operation or from a gas purification process, such as Rectisol®, containing a high concentration of carbon dioxide along with sulfur compounds such as methyl mercaptan, hydrogen sulfide, dimethyl disulfide, ethyl mercaptan, propyl mercaptan, dimethyl sulfide and the like is admixed with recycle gas in conduits 364 and 390 and is conveyed via conduit 310 to a compressor 312 for pressurization and further treatment according to the invention. The pressurized gas is conveyed through conduit 314 to a cooler/evaporator 316 which cools the compressed gas while also evaporating liquid waste-gas in conduit 325, which is subject to the control of level valve 343. The evaporated waste-gas leaves the unit through conduit 326 and is disposed of by incineration or is processed using other treatment methods. The cool compressed gas leaves the cooler/evaporator 316 through conduit 318. A portion of the gas in conduit 318 is routed through conduit 320 and into a reboiler 322 where it is used to concentrate the liquid waste-gas in conduit 324 by evaporating a portion of it. The evaporated waste-gas leaves the reboiler 322 in conduit 328 and returns to the absorber 330. The compressed gas used in the reboiler leaves in conduit 332 and blends back with the compressed gas from conduit 333 in conduit 334. The temperature valve 335 in conduit 333 controls the amount of heat applied to the reboiler 322 so that the correct bottoms flow is obtained from the column in conduit 324. Conduit 334 conveys the compressed gas to cooler/evaporator 336 where the compressed gas is cooled to near its condensation temperature by evaporating liquid carbon dioxide.

Treated carbon dioxide enters the cooler/evaporator 336 as a liquid through conduit 384 and leaves the cooler/evaporator as a vapor in conduit 386. The cold compressed sour feed gas is conveyed in conduit 342 to the absorber 330. The cold compressed sour feed gas flows upwardly through the absorber 330 where it is contacted with a downwardly flowing stream of liquid carbon dioxide. The liquid carbon dioxide absorbs methyl mercaptan along with various amounts of other sulfur compounds and collects in a sump 331 at the bottom of the absorber 330 to form a liquid waste-gas. The liquid waste-gas leaves the bottom of the absorber 330 through conduit 324 and is heated and evaporated as explained previously. Treated compressed gas leaves the top of the absorber 330 through conduit 344 and is conveyed to a compressor 350 where it is further pressurized for export in conduit 352. Before leaving the process, a slip stream of the high pressure gas is taken from conduit 352 in conduit 356 and across level valve 357 where a portion of the treated carbon dioxide gas is condensed by expansion at a lower pressure in flash vessel 358. That portion of the gas that is liquefied is used as both scrubbing liquor and refrigerant. The portion of the product or purified gas which is not used for refrigeration is exported to the consumer in conduit 354. The scrubbing liquor portion is withdrawn from vessel 358 in conduit 372 and fed under flow control through valve 374 into absorber 330. The refrigerant portion of the liquid carbon dioxide in vessel 358 is withdrawn through conduit 380 under control of valve 382 and fed into the cooler/evaporator 336 via conduit 384. Liquid refrigerant in conduit 384 enters the bottom of the condenser/evaporator 336 and leaves as a vapor in conduit 386 under the influence of pressure valve 388 and is recycled by means of conduit 390 to the inlet line 310 of compressor 312. The non-condensed portion of the gas in flash vessel 358 is withdrawn through conduit 360 under the influence of pressure valve 362 and recycled by means of conduit 364 to the inlet line 310 of compressor 312. Alternatively, under the appropriate operating conditions, the non-condensed portion of the gas can be recycled by means of conduit 366 to the inlet line 344 of compressor 350 and recompressed as sales gas.

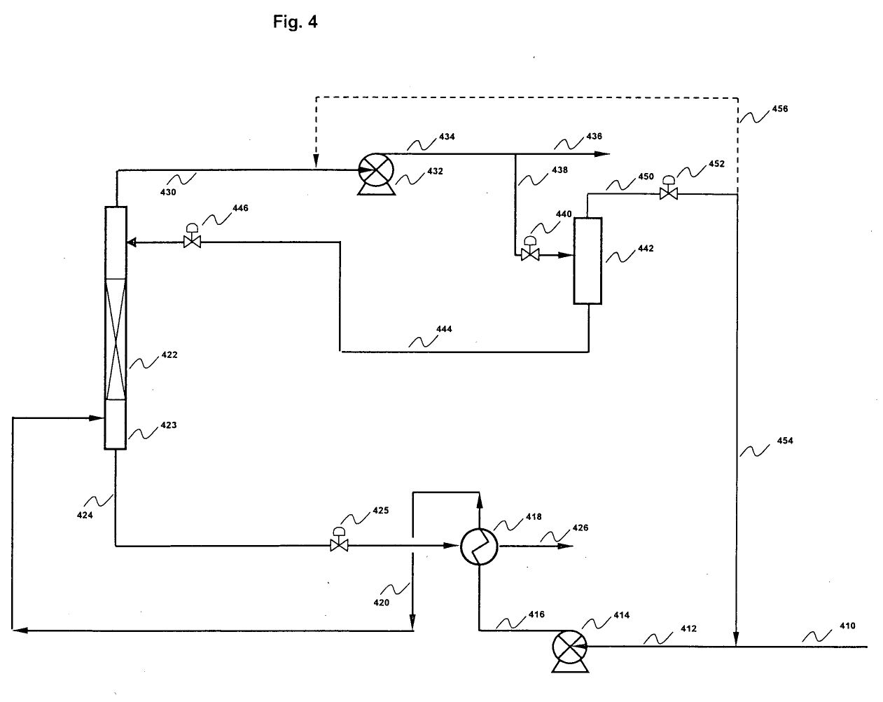

With reference to FIG. 4, a gas stream in conduit 410 from a coal gasification operation or from a gas purification process, such as Rectisol®, containing a high concentration of carbon dioxide along with sulfur compounds such as methyl mercaptan, hydrogen sulfide, dimethyl disulfide, ethyl mercaptan, propyl mercaptan, dimethyl sulfide and the like is admixed with recycle gas 454 and conveyed in conduit 412 to a compressor 414 for pressurization and further treatment according to the invention. The pressurized gas is conveyed through conduit 416 to a cooler/evaporator 418 which cools the compressed gas while also evaporating liquid waste-gas. The evaporated waste-gas leaves the unit through conduit 426 and is disposed of by incineration or is processed using other treatment methods. The warm compressed gas leaves the cooler/evaporator 418 through conduit 420. The warm compressed gas is conveyed in conduit 420 to the absorber 422. The warm compressed gas flows upwardly through the absorber 422 where it is contacted with a downwardly flowing stream of liquid carbon dioxide. The liquid carbon dioxide both cools the compressed gas and absorbs methyl mercaptan along with various amounts of other sulfur compounds. The liquid carbon dioxide collects in a sump 423 at the bottom of the absorber 422 to form a liquid waste-gas. The liquid waste-gas leaves the bottom of the absorber 422 through conduit 424 under the control of level valve 425 and is heated and evaporated as explained previously. Treated compressed gas leaves the top of the absorber 422 through conduit 430 and is conveyed to a compressor 432 where it is further pressurized for export in conduit 434. Before the product or purified gas from the process is exported to the consumer in conduit 436, a slip stream of the high pressure gas is taken from conduit 434 in conduit 438 and across level valve 440 where a portion of the treated carbon dioxide gas is condensed by expansion at a lower pressure in flash vessel 442. That portion of the gas that is liquefied is used as scrubbing liquor. The scrubbing liquor is withdrawn from vessel 442 in conduit 444 and fed under flow control through flow valve 446 into absorber 422. The non-condensed portion of the gas in flash vessel 442 is withdrawn through conduit 450 under the influence of pressure valve 452 and recycled by means of conduit 454 to the inlet line 412 of compressor 414. Alternatively, under the appropriate operating conditions, the non-condensed portion of the gas can be recycled by means of conduit 456 to the inlet line 430 of compressor 432 and recompressed as sales gas.

The following non-limiting example demonstrates various aspects of the invention.

### EXAMPLES 1-53

A 2200 lb/hr slip stream of a contaminated CO₂-rich off gas from a Rectisol® Unit inside a North Dakota coal gasification plant, having an average (but also highly variable) methyl mercaptan content of about 200 ppmv and containing 1.1 mole percent hydrogen sulfide, 95 ppmv carbonyl sulfide, 3 ppmv dimethyl disulfide, 1 ppmv ethyl mercaptan and trace amounts of carbon disulfide, propyl mercaptan and dimethyl disulfide, was processed in a continuous flow pilot plant. The pilot plant consisted of two CO₂ gas compressors in series, five heat exchangers, a packed absorption/distillation column, and an on-line analyzer for methyl mercaptan analysis. The pilot plant was operated over a range of conditions such that the raw feed gas was first compressed to between 280 psig and 360 psig. The compressed gas was then cooled either prior to the absorber or inside of it depending upon the mode of operation. The absorber operating temperature ranged between minus 3° F. and plus 13° F. depending on the pressure of operation, with the lower temperatures corresponding to the lower operating pressures. The cold feed gas was allowed to flow upwardly through the absorber where it was contacted with a downward flow of liquid carbon dioxide. The flow of liquid carbon dioxide was varied over a range of rates corresponding to 4 (Table 1, Example 40) to 25 (Table 1, Example 20) weight percent of the feed gas mass flow rate, resulting in an L/G ratio or reflux ratio in the range of 4 to 25 pounds of liquid carbon dioxide per 100 pounds of sour feed gas. Liquid carbon dioxide was collected in the sump at the bottom of the absorber, where the methyl mercaptan was concentrated by evaporating some of the carbon dioxide from the liquid using either warm feed gas or an electric reboiler as the heat source. This method of concentration typically reduced the bottoms flow of liquid to within the range of 1 to 5 weight percent of the weight flow of fresh feed gas. The evaporated gas from the concentration step was returned to the absorber for reprocessing. The liquid containing the methyl mercaptan was withdrawn from the bottom of the absorber and then vaporized using steam heat, after which it was fed into the combustion zone of a steam boiler for incineration and later recovery of the sulfur using a wet scrubber to produce ammonium sulfate fertilizer. The purified gas was withdrawn from the top of the absorber and a portion (4 to 25 weight percent of the feed gas mass flow rate) was condensed and returned to the absorber as scrubbing liquor. The remaining treated gas was removed from the pilot plant as product. The results are shown on Table 1.

The data in Table 1 shows that a significant reduction in methyl mercaptan was obtained by treating contaminated carbon dioxide gas with liquid carbon dioxide at pressures ranging from about 280 psig to 360 psig and at temperatures from about minus 3° F. to plus 13° F. Under some of the best conditions, such as were used in Runs 3, 19, 20, 33, 34 and 45, more than 99.5 percent of the methyl mercaptan was removed from the feed gas.

TABLE 1

| | | | | | | | | | | | | CH3SH Removal | CH3SH Removal | |
|---|---|---|---|---|---|---|---|---|---|---|---|---|---|---|
| | | | | | | | | | | | | From the | From the | |
| | | Column | | | | | Reflux or | Total | | | | Final Protect | Final Protect | |
| | | Configuration | | | Average | Average | Wash | Liquid CO2 | | Conc. of | Conc. of | Based on the | Based on the | |
| | | Feel of | | | Column | Overall | Rate, | Produced, | Conc. of | CH3SH | CH3SH | Concentration | Concentration | Final Protect |
| | Process | Packing | Operating | Feed Gas | Top | Column | Wt % of | Wt % of | CH3SH | in Column | in Final | Leaving the | Leaving the | Recovery as |
| | Configu- | above Feed | Pressure, | Temperature | Temperature, | Temperature | Feed Gas | Feed Gas | in Feed gas | Ovrhd Gas | Protect Gas | the Absorber | the Process | wt % of |
| Test No. | ration | Point | Psig | deg F. | deg F. | deg F. | Rate | Rate | ppm/ | ppm/ | ppm/ | % | % | Feed Gas |
| 1* | Absorber | 15 | 321 | 82 | 7.0 | 11.7 | 17.9% | 39.0% | 196 | 150.0 | 65.0 | 23.5% | 68.8% | 99.0% |
| 2 | Absorber | 15 | 321 | 85 | 6.2 | 9.2 | 19.8% | 54.6% | 198 | 5.2 | 0.0 | 97.4% | 100.0% | 97.9% |
| 3 | Absorber | 15 | 321 | 84 | 5.6 | 7.5 | 21.8% | 25.8% | 210 | 0.4 | 0.0 | 99.8% | 100.0% | 95.7% |
| 4 | Absorber | 15 | 321 | 85 | 6.5 | 10.5 | 18.9% | 28.0% | 186 | 9.0 | 4.0 | 95.2% | 97.8% | 98.7% |
| 5 | Absorber | 15 | 321 | 57 | 5.9 | 7.9 | 16.8% | 24.4% | 196 | 11.0 | 5.0 | 94.4% | 97.4% | 96.9% |
| 6 | Absorber | 15 | 321 | 53 | 6.1 | 7.9 | 12.6% | 33.5% | 178 | 70.0 | 17 | 60.7% | 90.4% | 98.0% |
| 7 | Absorber | 15 | 321 | 59 | 6.0 | 7.7 | 14.4% | 19.1% | 145 | 21.0 | 7.6 | 85.5% | 94.8% | 97.5% |
| 8 | Absorber | 15 | 321 | 77 | 5.8 | 8.0 | 18.7% | 37.4% | 145 | 2.9 | 0.9 | 98.0% | 99.4% | 97.3% |
| 9 | Absorber | 15 | 361 | 69 | 13.1 | 15.4 | 15.9% | 25.8% | 186 | 28.3 | 12.4 | 84.8% | 93.3% | 97.2% |
| 10 | Absorber | 15 | 281 | 75 | −3.0 | 0.3 | 19.2% | 23.6% | 134 | 2.0 | 0.9 | 98.5% | 99.3% | 97.8% |
| 11 | Absorber | 15 | 300 | 70 | 1.0 | 4.1 | 17.6% | 28.5% | 144 | 4.0 | 1.7 | 97.2% | 98.8% | 97.7% |
| 12 | Absorber | 15 | 320 | 68 | 4.7 | 7.1 | 17.2% | 61.2% | 195 | 15.0 | 0 | 92.3% | 100.0% | 97.0% |
| 13 | Absorber | 15 | 340 | 68 | 8.3 | 10.6 | 16.2% | 24.4% | 140 | 9.8 | 4.1 | 93.0% | 97.1% | 97.3% |
| 14 | Absorber | 15 | 360 | 71 | 11.7 | 14.2 | 16.2% | 33.9% | 119 | 17.4 | 7 | 85.4% | 93.6% | 97.8% |
| 15A | Distillation | 15 | 360 | 12 | 11.0 | 12.5 | 21.1% | 29.7% | 176 | 3.0 | 1 | 98.3% | 93.8% | 97.7% |
| 15B | Distillation | 15 | 360 | 12 | 11.0 | 12.5 | 19.8% | 34.4% | 210 | 7 | 2 | 96.7% | 99.0% | 97.0% |
| 16 | Distillation | 15 | 339 | 8 | 7.4 | 8.8 | 19.6% | 26.0% | 210 | 4 | 2 | 98.1% | 99.0% | 97.2% |
| 17 | Distillation | 15 | 320 | 5 | 3.9 | 5.4 | 20.0% | NA | 200 | 4 | 2 | 98.0% | 99.0% | 96.8% |
| 18 | Distillation | 15 | 300 | 2 | 0.3 | 1.8 | 19.4% | 28.3% | 153 | 1.5 | 0.5 | 99.0% | 99.7% | 98.0% |
| 19 | Distillation | 15 | 300 | 2 | 1.0 | 2.0 | 20.7% | 32.0% | 181 | 0.7 | 0.7 | 99.6% | 99.6% | 98.0% |
| 20 | Distillation | 15 | 299 | 2 | 0.8 | 1.9 | 24.7% | 26.9% | 212 | 0 | 0 | 100.0% | 100.0% | 97.8% |
| 21 | Distillation | 15 | 300 | 3 | 1.2 | 2.2 | 16.5% | 27.1% | 193 | 5.1 | 2.1 | 97.4% | 98.9% | 97.1% |
| 22 | Distillation | 15 | 300 | 3 | 1.4 | 2.4 | 14.4% | 33.9% | 205 | 10 | 2.9 | 95.1% | 98.6% | 97.2% |
| 23 | Distillation | 15 | 300 | 3 | 1.4 | 2.4 | 12.6% | 31.9% | 180 | 21.2 | 5.5 | 88.2% | 96.9% | 97.9% |
| 24 | Distillation | 15 | 300 | 3 | 1.4 | 2.4 | 14.6% | 23.2% | 203 | 11.5 | 3.9 | 94.3% | 98.1% | 97.3% |
| 25 | Distillation | 15 | 300 | 3 | 1.5 | 2.5 | 11.4% | 32.4% | 200 | 48 | 13 | 76.0% | 93.5% | 97.7% |
| 26 | Distillation | 15 | 300 | 3 | 1.3 | 2.3 | 17.7% | 26.7% | 248 | 4.3 | 1.6 | 98.3% | 99.4% | 96.0% |
| 27 | Absorber | 27 | 290 | 71 | −0.1 | 3.0 | 18.0% | 31.5% | 197 | 4 | 1 | 90.0% | 99.5% | 97.7% |
| 28 | Absorber | 27 | 290 | 60 | 0.0 | 2.4 | 15.8% | 26.7% | 187 | 7.2 | 2.7 | 96.1% | 98.6% | 97.4% |
| 29 | Absorber | 27 | 290 | 74 | −0.1 | 2.6 | 19.4% | NA | 186 | 2 | 1.9 | 98.9% | 99.0% | 97.1% |
| 30 | Absorber | 27 | 290 | 55 | 0.0 | 2.3 | 15.6% | 44.9% | 211 | 19 | 5 | 91.0% | 97.6% | 96.6% |
| 31 | Absorber | 27 | 290 | 46 | 0.1 | 2.1 | 13.4% | 20.3% | 222 | 25.6 | 9.8 | 88.5% | 95.6% | 96.9% |
| 32 | Absorber | 27 | 290 | 20 | 0.0 | 1.4 | 7.1% | NA | 182 | 75 | 38.1 | 58.8% | 79.1% | 97.6% |
| 33 | Absorber | 27 | 290 | 78 | −0.3 | 0.3 | 18.4% | 22.3% | 138 | 0.1 | 0 | 99.9% | 100.0% | 98.8% |
| 34 | Absorber | 27 | 290 | 54 | −0.4 | 0.0 | 15.2% | 16.8% | 154 | 0.3 | 0 | 99.8% | 100.0% | 96.7% |
| 35 | Absorber | 27 | 290 | 37 | −0.4 | −0.1 | 12.5% | 20.4% | 209 | 5.4 | 1.9 | 97.4% | 99.1% | 95.7% |
| 36 | Absorber | 27 | 290 | 15 | −0.5 | −0.2 | 10.8% | 15.1% | 244 | 12 | 5 | 95.1% | 98.0% | 92.6% |
| 37 | Absorber | 27 | 290 | 44 | −0.5 | −0.1 | 14.1% | NA | 245 | 2 | 0 | 99.2% | 100.0% | 95.6% |
| 38 | Absorber | 27 | 290 | 23 | −0.3 | 0.0 | 11.0% | 25.4% | 289 | 47.4 | 12.7 | 83.6% | 95.6% | 94.0% |
| 39 | Absorber | 27 | 290 | 15 | −0.2 | 0.1 | 7.5% | 20.7% | 284 | 139 | 53 | 51.1% | 81.3% | 95.8% |
| 40 | Distillation | 27 | 290 | 1 | 0.0 | 0.1 | 4.3% | NA | 267 | 258 | 166 | 1.4% | 37.8% | 99.9% |
| 41 | Distillation | 27 | 290 | 1 | −0.4 | −0.2 | 10.3% | 23.8% | 329 | 39.4 | 13.6 | 88.0% | 95.9% | 97.0% |
| 42 | Distillation | 27 | 290 | 4 | −0.4 | −0.2 | 8.4% | 39.5% | 238 | 76 | 18 | 68.1% | 92.4% | 97.7% |
| 43 | Distillation | 27 | 290 | 4 | −0.6 | −0.4 | 11.3% | 28.0% | 247 | 19 | 5.7 | 92.3% | 97.7% | 96.8% |
| 44 | Distillation | 27 | 290 | 4 | −0.7 | −0.4 | 13.7% | 37.0% | 251 | 2 | 0 | 99.2% | 100.0% | 97.2% |
| 45 | Distillation | 27 | 290 | 4 | −0.7 | −0.3 | 15.2% | NA | 200 | 0.7 | 0.5 | 99.7% | 99.8% | 97.4% |
| 46 | Distillation | 27 | 290 | 4 | −0.4 | −0.2 | 8.5% | NA | 220 | 78 | 15 | 64.5% | 93.2% | 98.1% |
| 47 | Distillation | 27 | 290 | 4 | −0.6 | −0.4 | 12.9% | 18.0% | 225 | 5.2 | 2.1 | 97.7% | 99.1% | 97.2% |
| 48 | Distillation | 27 | 300 | 6 | 1.5 | 1.7 | 8.5% | 33.0% | 205 | 58 | 15 | 71.7% | 92.7% | 98.1% |
| 49 | Distillation | 27 | 300 | 6 | 1.3 | 1.5 | 12.1% | 32.0% | 177 | 10 | 3 | 94.4% | 98.3% | 97.7% |
| 50 | Distillation | 27 | 300 | 6 | 1.4 | 1.6 | 10.3% | 36.7% | 198 | 56 | 11 | 71.7% | 94.4% | 98.2% |
| 51 | Distillation | 27 | 300 | 6 | 1.2 | 1.4 | 14.2% | 33.9% | 175 | 3.2 | 0.9 | 98.2% | 99.5% | 97.7% |
| 52A | Distillation | 27 | 300 | 6 | 1.2 | 1.4 | 12.2% | 34.6% | 171 | 18.4 | 4.1 | 89.2% | 97.6% | 97.6% |
| 52B | Distillation | 27 | 300 | 6 | 1.3 | 1.5 | 12.0% | NA | 154 | 21 | 12 | 87.2% | 92.7% | 97.9% |
| 52C | Distillation | 27 | 300 | 6 | 1.3 | 1.5 | 12.6% | 24.9% | 157 | 12 | 5 | 92.4% | 96.8% | 97.9% |
| 52D | Distillation | 27 | 300 | 6 | 1.4 | 1.6 | 11.4% | 23.7% | 148 | 19 | 8 | 87.2% | 94.6% | 98.5% |
| 53 | Distillation | 27 | 300 | 6 | 1.4 | 1.6 | 9.8% | 20.3% | 159 | 38 | 15 | 76.1% | 90.6% | 98.1% |

NA = Not Available
*low CH3SH removal attributed to start-up conditions

Having now described and illustrated the preferred embodiments of the invention, it will be appreciated by those of appropriate skill that various modifications, rearrangements and substitutions may be made to the invention within the spirit and scope of the appended claims.

1. A method of removing methyl mercaptan from a carbon dioxide gas stream, comprising the steps of:
(a) obtaining a first gas stream comprising at least 80 volume percent carbon dioxide and up to 500 parts per million based on volume of methyl mercaptan, and
(b) contacting said first gas stream with a liquid carbon dioxide stream under conditions sufficient to produce a first liquid stream containing at least 85 weight percent of said methyl mercaptan from said first gas stream and a second gas stream containing at least 90 weight percent of said carbon dioxide from said first gas stream.

2. A method according to claim 1, wherein the contacting step takes place in a column having a reflux ratio of at least eight pounds of said liquid carbon dioxide stream per 100 pounds of said first gas stream.

3. A method according to claim 1, wherein the contacting step takes place in an absorber.

4. A method according to claim 1, wherein the contacting step takes place in a distillation column.

5. A method according to claim 2, wherein the contacting step takes place in an absorber.

6. A method according to claim 2, wherein the contacting step takes place in a distillation column.

7. A method according to claim 1, further comprising the step of:
(c) compressing said first gas stream prior to step (b).

8. A method according to claim 7, further comprising the step of:
(d) cooling the compressed first gas stream prior to step (b).

9. A method according to claim 1, further comprising the step of:
(e) dehydrating the first gas stream prior to step (b).

10. A method according to claim 1, wherein at least a portion of said second gas stream is condensed to form said liquid carbon dioxide stream.

11. A method according to claim 2, wherein at least a portion of said second gas stream is condensed to form said liquid carbon dioxide stream.

12. A method according to claim 8, wherein at least a portion of said second gas stream is condensed and used to cool said first gas stream.

13. A method according to claim 8, wherein at least a portion of said first liquid stream cools said first gas stream.

14. A method according to claim 12, wherein at least a portion of said first liquid stream cools said first gas stream.

15. A method according to claim 1, wherein said contacting step takes place in a column having an operating pressure in the range of 280-360 psig.

16. A method according to claim 1, wherein the contacting step takes place in a column having a temperature in the range of −5 to 15° F. at the top of the column.

17. A method according to claim 1, wherein at least a portion of said second gas stream is cooled by conventional refrigeration.

18. A method according to claim 1, wherein at least a portion of said second gas stream is cooled by autorefrigeration.

19. A method according to claim 1, wherein said autorefrigeration takes place in an absorption column or a heat exchanger.

20. A method according to claim 1, wherein the methyl mercaptan content of said second gas stream is no more than 10 parts per million based on volume.

21. A method according to claim 1, wherein said second gas stream contains at least 95 weight percent of the gas components from said first gas stream.

22. A method according to claim 21, wherein the methyl mercaptan content of said second gas stream is no more than 10 parts per million based on volume.

23. A method according to claim 1, wherein said second gas stream contains at least 97 weight percent of the gas components from said first gas stream.

24. A method according to claim 1, wherein said second gas stream contains at least 99 weight percent of the gas components from said first gas stream.

25. A method according to claim 2, further comprising the step of: (f) concentrating said methyl mercaptan in said first liquid stream by reboiling said first liquid stream to evaporate a portion of the carbon dioxide therein and recycling said evaporated carbon dioxide to step (b).

26. A method of removing methyl mercaptan from a carbon dioxide gas stream, comprising the steps of:
(a) obtaining a first gas stream comprising at least 80 volume percent carbon dioxide and up to 500 parts per million based on volume of methyl mercaptan, and
(b) compressing said first gas stream to a pressure of 70 psig to 1100 psig,
(c) cooling said first gas stream to a temperature of −60° F. to 90° F.,
(d) contacting said first gas stream with an absorbent to produce a first liquid stream containing at least 85 weight percent of said methyl mercaptan from said first gas stream and a second gas stream containing at least 90 weight percent of said carbon dioxide from said first gas stream.

27. A method according to claim 26, wherein at least a portion of said first liquid stream cools said first gas stream.

28. A method according to claim 26, wherein said absorbent is liquid carbon dioxide.

29. A method according to claim 28, wherein the contacting step takes place in a column having a reflux ratio of 8 to 16 pounds of liquid carbon dioxide per 100 pounds of said first gas stream.

30. A method according to claim 28, wherein the contacting step takes place in a column having a reflux ratio of 10 to 14 pound of liquid carbon dioxide per 100 pounds of said first gas stream.
